(19) United States
(12) Patent Application Publication
(10) Pub. No.: US 2013/0263749 A1
(43) Pub. Date: Oct. 10, 2013

(54) Litho Strip for Electrochemical Roughening and Method for its Manufacture

(71) Applicants: Bernhard Kernig, Koln (DE); Christoph Settele, Monchengladbach (DE); Olaf Güßgen, Langenfeld (DE)

(72) Inventors: Bernhard Kernig, Koln (DE); Christoph Settele, Monchengladbach (DE); Olaf Güßgen, Langenfeld (DE)

(73) Assignee: Hydro Aluminium Rolled Products GmbH, Grevenbroich (DE)

(21) Appl. No.: 13/866,639

(22) Filed: Apr. 19, 2013

Related U.S. Application Data
(63) Continuation of application No. PCT/EP2011/067896, filed on Oct. 13, 2011.

(30) Foreign Application Priority Data
Oct. 22, 2010 (EP) 10188553.1

(51) Int. Cl. B41N 3/03

(52) U.S. Cl. CPC B41N 3/03
USPC 101/368; 216/102; 428/687; 428/141

(57) ABSTRACT

The invention relates to a litho sheet for electrochemical roughening, consisting of a rolled aluminium alloy, wherein the sheet surface has a topography with a maximum peak height Rp or Sp of not more than 1.4 [mu]m, preferably not more than 1.2 [mu]m, in particular not more than 1.0 [mu]m. The invention also relates to a method which is intended for producing a litho sheet and in the case of which a litho sheet consisting of an aluminium alloy is cold-rolled and in the case of which the litho sheet, following the final cold-rolling pass, is subjected to a degreasing treatment with a pickling step using an aqueous pickling medium.

### CROSS-REFERENCE TO RELATED PATENT APPLICATIONS

This patent application is a continuation of PCT/EP2011/067896, filed Oct. 13, 2011, which claims priority to European Application No. 10188553.1, filed Oct. 22, 2010, the entire teachings and disclosure of which are incorporated herein by reference thereto.

### FIELD OF THE INVENTION

This invention relates to a litho strip for electrochemical roughening consisting of a rolled aluminium alloy. The invention further relates to a method for the manufacture of a litho strip of this type, in which a litho strip consisting of an aluminium alloy is cold rolled and in which after the final cold rolling action the litho strip is subject to a degreasing process with a simultaneous pickling process in an aqueous pickling medium, wherein the aqueous pickling medium contains at least 1.5% to 3% by weight of a mixture of 5% to 40% sodium tripolyphosphate, 3% to 10% sodium gluconate, 3% to 8% non-ionic and anionic surfactants and optionally 0.5% to 70% soda and the sodium hydroxide concentration in the aqueous pickling medium is between 0.1% and 5% by weight. Finally, the invention also relates to a method for the manufacture of a printing plate carrier and its advantageous use.

### BACKGROUND OF THE INVENTION

Particularly high requirements are placed on the surface conditions of litho strips, in other words of aluminium strips for the manufacture of lithographic printing plates. Litho strips are generally subject to a process of electrochemical roughening, the aim of which is to ensure a complete roughening and an appearance of no structure. The roughened structure is important for placing a photosensitive layer on the printing plate carriers manufactured from the litho strips. In order to manufacture an equally roughened surface, a particularly flat surface is required on the litho strips. The topography of the litho strip surface is essentially an imprint of the rolling topography of the final cold rolling step. Elevations and recesses in the rolling surface lead to grooves and webs in the litho strip surfaces which can in part remain in the further processing steps in the manufacture of the printing plate carriers. The quality of the litho strip surfaces and therefore of the printing plate carries is therefore determined by the quality of the rolling surfaces and thus on the one hand by the grinding action when treating the surface of the rollers and on the other hand by ongoing wear to the rollers.

A measurement to determine the quality of the surface of the litho strip is the average roughness Rₐ in accordance with DIN EN ISO 4287 and DIN EN ISO 4288. In the current method for the manufacture of litho strips, surfaces with a usual average roughness value Rₐ of around 0.15 μm to 0.25 μm are generate in the final cold rolling step. These roughness values are sufficient for many areas of application.

However, in the past few years there has been an increasing demand for printing plates with very flat roughening structures and/or a relatively photosensitive coating. These are used, for example, in the field of CtP technology, which is increasing in size and in which the printing plates can be illuminated directly using a computer. Furthermore, the thickness of the coating is decreasing and its complexity is increasing. The number of printing errors is increasing when the currently available printing plate carriers are used in this way. A flat topography of the litho strip after rolling is therefore a quality criterion for litho strips which is becoming ever more important.

An attempt has been made to optimise the grinding of the rollers in order to obtain flat roller structures. However, the grinding actions have already been extensively optimised, so further increases in quality are very difficult to achieve in this way. Furthermore, the quality of the surfaces of the rollers decreases after grinding as a result of wear to the rollers, so it is frequently necessary to re-grind the rollers. Ultimately, very flat roller surfaces only exert a small amount of friction on the litho strip surfaces, potentially resulting in a slip between the roller and the litho strip which causes a disruption to the rolling process or damage to the litho strip.

Printing plate carriers for lithographic printing are known from EP 1 172 228 A2, EP 0 778 158 A1 and EP 1 232 878 A2.

In other known methods from the prior art from WO 2006/122852 A1 and WO 2007/141300 A1, the litho strips are pickled after rolling in order to remove damaging pockets of oxides on the surface of the strips and therefore to improve the subsequent electrochemical roughening. In this way, the surface quality of the printing plate carriers can in principle be improved, but the problem of printing errors mentioned above remains.

### SUMMARY OF THE INVENTION

Starting from the prior art, the object of the present invention is to provide a litho strip and a method for its manufacture with which the above mentioned disadvantages from the prior art can be avoided or at least reduced.

This object is achieved according to the invention in a suitable litho strip by the strip surface having a topography with a maximum peak height Rₚ and/or Sₚ of a maximum of 1.4 μm, preferably a maximum of 1.2 μm, more preferably a maximum of 1.0 μm.

The topography of a strip surface means its deviation from an ideal plane. It can be described using a function Z(x, y), which indicates the local deviation from the average height of the surface at each point along the surface (x, y). In accordance with this, the average value of the function Z(x, y), in other words the position of the average surface, is set at 0, as shown by the following formula:

$$〈 Z ( x , y ) 〉 = \frac{1}{F} \int \int Z ( x , y ) d x d y = 0 \qquad ( 1 )$$

F is the size of the integration surface. Local elevations correspond to positive values and local dips correspond to negative values of Z (x, y).

The features of a topography of this type can be determined using various parameters. A usual parameter is the average roughness Rₐ or the average quadratic roughness R_{q} in accordance with DIN EN ISO 4287 and DIN EN ISO 4288. These parameters can be defined using the following equation:

$${R}_{a} = \frac{1}{L} \int \vert Z ( x ) \vert d x \\ {R}_{q} = \sqrt{\frac{1}{L} \int {Z ( x )}^{2} d x} \qquad ( 2 )$$

Z(x) is a profile of the surface, in other words a one-dimensional section through the function Z(x, y). L is the length of the integration interval. In order to determine the surface quality of a surface, one-dimensional profiles Z(x) are generally measured by means of linear scanning at various locations on the surface and the corresponding Rₐ and R_{q} values are determined.

The values for Sₐ and S_{q} are determined on the basis of a two-dimensional measurement of the surface, in other words the topography Z(x, y). The calculation of the values Sₐ and S_{q} is made on the basis of the following equation, wherein A is the size of the integration surface:

$${S}_{a} = \frac{1}{A} \int \int \vert Z ( x , y ) \vert d x d y \\ {S}_{q} = \sqrt{\frac{1}{A} \int \int {Z ( x , y )}^{2} d x d y} \qquad ( 3 )$$

In the context of the present invention, it was recognised that the printing errors which occur in the prior art are often caused by individual, particularly high roller webs, which in part remain in the manufacture of pressure plate carriers. When coating the pressure plate carriers, this can lead to interruptions in the photosensitive layer in the region of these roller webs, which in turn causes printing errors in the use of the completed printing plates. The high roller webs have proven to be particularly problematic in printing plates with a flat roughening structure and/or a relatively thin photosensitive coating.

The existence of individual high roller webs is, however, only insufficiently included in the parameters Rₐ and Sₐ used to date to characterise the litho strip surfaces. In contrast to this, the likelihood of high roller webs and, therefore, the occurrence of the above mentioned printing errors can be reduced by the litho strip and the method for its manufacture being optimised in terms of another, as yet unused roughness value. By limiting the maximum peak height Rₚ and/or Sₚ to a maximum of 1.4 μm, preferably a maximum of 1.2 μm, more preferably a maximum of 1.0 μm, litho strips can be provided which are sufficient for the current high requirements in terms of surface quality, for example when using CtP technology.

In order to determine the maximum peak height Rₚ of a litho strip, three positions on the litho strip can generally be measured transverse to the roller direction profile Z(x) over a length of, for example, 4.8 mm in each case, in order to determine a value for Rₚ. For each of these profiles, the following applies:

Rₚmax(Z(x)), (4)

wherein the function max(Z) provides the maximum value of Z(x). Sₚ is determined using a surface measurement with the equation

Sₚ=max(Z(x,v)) (5)

wherein the function max(Z) provides the maximum value of Z(x, y). The surface to be measured can in practice be, for example, quadratic and have an edge length of 800 μm.

Preferably, a profile Z(x) is measured at each of the centre and the sides of the litho strip to determine the maximum peak height Rₚ.

It is understood that for the measurement of the profile Z(x) and the topography Z(x, y) only those regions of the litho strip which will later be further processed into printing plate carriers are taken into consideration. Damaged regions or regions with roller defects are, for example, not taken into account.

In a first embodiment of the litho strip, the surface of the strip has a topography with a reduced peak height Rₚₖ and/or Sₚₖ of a maximum of 0.4 μm, preferably a maximum of 0.37 μm. It has been demonstrated that the quality of the strip surfaces in terms of a lack of printing errors can be further improved by an additional check of the reduced peak height Rₚₖ and/or Sₚₖ.

The reduced peak height Rₚₖ is determined in accordance with DIN EN ISO 13 5 65. The reduced peak height Sₚₖ is determined in accordance with DIN EN ISO 13 565 using a surface measurement. In practice, the profiles Z(x) and the topography Z(x, y) are measured as described above for Rₚ and Sₚ.

In a further embodiment, the thickness of the litho strip is 0.5 mm to 0.1 mm. It has been shown that conventional litho strips of a low thickness can have high roller webs. The surface quality of thin litho strips can, therefore, be improved in particular by limiting the maximum peak height Rₚ and/or Sₚ or the reduced peak height Rₚₖ and/or Sₚₖ.

In a further embodiment of the litho strip, good material features of the litho strips are achieved by the litho strip consisting of an AA1050, AA1100, AA3103 or AlMg0.5 alloy.

In a further preferred embodiment the litho strip has the following alloy compositions in percent by weight:

$$\begin{matrix}0.3 \% & \leq & Fe & \leq & 1.0 \% \\ 0.05 \% & \leq & Mg & \leq & 0.6 \% \\ 0.05 \% & \leq & Si & \leq & 0.25 \% \\ & & Mn & \leq & 0.05 \% \\ & & Cu & \leq & 0.04\end{matrix} \vert$$

plus residual Al and unavoidable impurities, to an individual maximum of 0.05% and totaling a maximum of 0.15%.

In this way, the litho strip can be improved in a targeted manner for use in terms of its strength and heat resistance characteristics.

High resistance to bending and simultaneously very good thermal stability of the litho strip can be achieved in a further embodiment by the litho strip having the following alloy content in percent by weight:

$$\begin{matrix}0.3 \% & \leq & Fe & \leq & 0.4 \% \\ 0.2 \% & \leq & Mg & \leq & 0.6 \% \\ 0.05 \% & \leq & Si & \leq & 0.25 \% \\ & & Mn & \leq & 0.05 \% \\ & & Cu & \leq & 0.04 \%\end{matrix}$$

In a further preferred embodiment the litho strip has the following alloy contents in percent by weight:

$$\begin{matrix}0.3 \% & \leq & Fe & \leq & 0.4 \% \\ 0.1 \% & \leq & Mg & \leq & 0.3 \% \\ 0.05 \% & \leq & Si & \leq & 0.25 \% \\ & & Mn & \leq & 0.05 \% \\ & & Cu & \leq & 0.04 \%\end{matrix} \vert$$

In this way, the roughening characteristics and the heat resistance of the litho strip can be improved.

In accordance with a further embodiment, the impurities in the alloy of the litho strip have the following threshold values in percent by weight:

$$\begin{matrix}Cr & \leq & 0.01 \% \\ Zn & \leq & 0.02 \% \\ Ti & \leq & 0.04 \% \\ B & \leq & 50 ppm .\end{matrix}$$

Titanium can also be intentionally added for grain refinement up to a concentration of 0.04% by weight.

In a further teaching of the invention in a suitable method for manufacturing a litho strip in accordance with the invention, the above mentioned object is achieved by the surface erosion caused by degreasing treatment with simultaneous pickling being at least 0.25 g/m², preferably at least 0.4 g/m².

It is recognised that the high roller webs on the litho strip surfaces which cause disruptions can be reduced after the final cold rolling step by a specific degreasing treatment. Pickling treatments to remove pockets of oxides are known, the targeted removal of roller webs was not previously known. By the special selection of the pickling and degreasing medium and the process parameters, it is now possible, however, to achieve a topography of the litho strip surface either instead or additionally which has a much lower susceptibility to errors than the litho strips previously known due to high roller webs. Since the degreasing treatment with a pickling step is a very critical process for litho strips, the method requires a very careful selection of process parameters. In particular, the composition of the pickling medium and the pickling temperature and duration should be set such that during the degreasing treatment with pickling, surface erosion of at least 0.25 g/m² is achieved on the litho strip surfaces. In this way, a topography of the litho strip surfaces can be achieved with a maximum peak height Rₚ and/or Sₚ of a maximum of 1.4 μm, preferably a maximum of 1.2 μm, more preferably a maximum of 1.0 μm.

Surface erosion means the weight of the litho strip removed during the degreasing treatment and pickling per surface. In order to determine the surface erosion, the litho strip is weighed before and after the degreasing treatment with pickling. The loss in weight calculated as a result divided by the size of the surface treated gives the surface erosion. If both sides of the litho strip are subject to degreasing treatment with pickling, the surface on the front side and the rear side should subsequently be added.

A surface erosion of between 0.25 g/m² and 0.6 g/m², preferably between 0.4 g/m² and 0.6 g/m² has been shown to be particularly advantageous. In this way, the erosion is on the one hand high enough to reduce the high webs, and on the other hand does not reduce the thickness of the litho strip too much. In principle, however, the erosion should be kept as low as possible so the material loss during the degreasing treatment with pickling is as low as possible.

In a preferred embodiment of the method, the topography of the litho strip surface can be improved by the sodium hydroxide concentration in the aqueous pickling medium being between 2% and 3.5% by weight and optionally by the degreasing treatment with pickling taking place at temperatures between 70 and 85° C. for a duration of between 1 and 3.5 seconds. At these concentrations, temperatures and treatment durations, the topography according to the invention can be achieved in a particularly reliable manner.

A further improvement is achieved by the sodium hydroxide concentration in the aqueous pickling medium being between 2.6% and 3.5% by weight and/or the pickling temperature being between 76 and 84° C. This enables a shorter treatment duration with a removal of the high roller webs which is nevertheless homogeneous. A further improvement in the speed of the degreasing treatment with pickling of the litho strip can be achieved by the pickling duration being between 1 and 2 seconds, preferably between 1.1 and 1.9 seconds.

In accordance with a further embodiment of the method, the litho strip is rolled in the final cold rolling step to a final thickness of 0.5 mm to 0.1 mm. In this roller thickness which is preferably used, roller webs occur particularly frequently which can be reduced considerably through the degreasing treatment with pickling.

AA1050, AA1100, AA3103 or AlMg0.5 is used as an aluminium alloy in accordance with a further embodiment. These aluminium alloys have proven to be particularly advantageous for the features of the litho strips.

In a further embodiment of the method, the aluminium alloy has the following composition in percent by weight:

$$\begin{matrix}0.3 \% & \leq & Fe & \leq & 1.0 \% \\ 0.1 \% & \leq & Mg & \leq & 0.6 \% \\ 0.05 \% & \leq & Si & \leq & 0.25 \% \\ & & Mn & \leq & 0.05 \% \\ & & Cu & \leq & 0.04 \%\end{matrix} \vert$$

plus residual Al and unavoidable impurities, to an individual maximum of 0.05% and totaling a maximum of 0.15%.

The effect of the degreasing treatment with pickling is influenced by the alloy of the litho strip. It has been determined that with this alloy composition very good results in terms of the surface topography and simultaneously good material characteristics of the litho strips can be achieved with the selected process parameters for the degreasing treatment with pickling.

In further embodiments of the method, the aluminium alloy has the following alloy contents in percent by weight:

$$\begin{matrix}0.3 \% & \leq & Fe & \leq & 0.4 \% \\ 0.1 \% & \leq & Mg & \leq & 0.3 \% \\ 0.05 \% & \leq & Si & \leq & 0.25 \% \\ & & Mn & \leq & 0.05 \% \\ & & Cu & \leq & 0.04 \%\end{matrix}$$

The impurities in the alloy of the litho strip have the following threshold values in accordance with a further embodiment:

$$\begin{matrix}Cr & \leq & 0.01 \% \\ Zn & \leq & 0.02 \% \\ Ti & \leq & 0.04 \% \\ B & \leq & 50 ppm ,\end{matrix}$$

wherein titanium can also be intentionally added for grain refinement up to a concentration of 0.04% by weight.

Reference is made to the relevant embodiment of the litho strip for the advantages of the preferred alloy compositions.

In a further embodiment of the method, the structural features of the litho strip can be improved by the litho strip being warm rolled before the cold rolling and optionally by a homogenisation treatment being carried out before the heat rolling and/or intermediate annealing being carried out during the cold rolling.

The above mentioned object is achieved in accordance with a further teaching of the present invention by a printing plate carrier having a topography with a maximum peak height Rₚ and/or Sₚ up to a maximum of 1.4 μm, preferably 1.2 μm, more preferably 1.0 μm. The printing plate carrier is preferably manufactured from a litho strip in accordance with the invention.

In a preferred embodiment of the printing plate carrier, said printing plate carrier has a photosensitive coating with a thickness of less than 2 μm, preferably less than 1 μm.

The high roller web in previous litho sheets led to printing errors, particularly with thin photosensitive coatings, so that in this case a particular improvement in printing plate quality is achieved. The printing plate carrier preferably has a transparent photosensitive layer which offers advantages on exposure. In these layers, the complete covering of the printing plate carrier can only be determined after printing, so faulty printing plate carriers are very costly. By improving the topography and as a result reducing the printing errors, the costs caused by printing errors can be reduced considerably.

The printing plate carrier can preferably have a width of 200 mm to 2,800 mm, more preferably 800 mm to 1,900 mm, most preferably 1,700 mm to 1,900 mm, and a length of 300 mm to 1,200 mm, more preferably 800 mm to 1,200 mm.

The printing plate carrier according to the invention can preferably be used in CtP technology, in other words for a CtP printing plate. In CtP technology, the surface structure of the printing plate carrier is particularly critical since the flat roughening structures and the relatively thin photosensitive coating can lead to increased numbers of printing errors with high roller webs. In addition to this, transparent photosensitive layers are frequently used in CtP technology, leading to the above mentioned problems. Due to the flat topography of the printing plate carrier in accordance with the invention as compared with printing plate carriers in the prior art, the printing quality can be improved and the costs reduced.

### BRIEF DESCRIPTION OF THE DRAWINGS

Further features and advantages of the present invention can be derived from the following description of embodiments of the litho strip in accordance with the invention and the method in accordance with the invention, in which the attached diagrams are taken into account, in which:

FIG. 1 is a schematic view of the determination of the maximum peak height Rₚ and the reduced peak height Rₚₖ in accordance with DIN EN ISO 13 565,

FIG. 2 is an embodiment of the method in accordance with the invention,

FIG. 3 shows the results of a topographic measurement of a litho strip surface after the final cold rolling,

FIG. 4 is a profile from the topographic measurement shown in FIG. 3,

FIG. 5 shows the results of a topographic measurement of the litho strip surface shown in FIG. 3 after an embodiment of the method in accordance with the invention is carried out,

FIG. 6 is a profile from the topographic measurement shown in FIG. 5,

FIG. 7 shows the results of a topographic measurement of a litho strip surface after the final cold rolling and

FIG. 8 shows the results of a topographic measurement of the litho strip surface shown in FIG. 7 after an embodiment of the method in accordance with the invention is carried out.

### DETAILED DESCRIPTION OF THE INVENTION

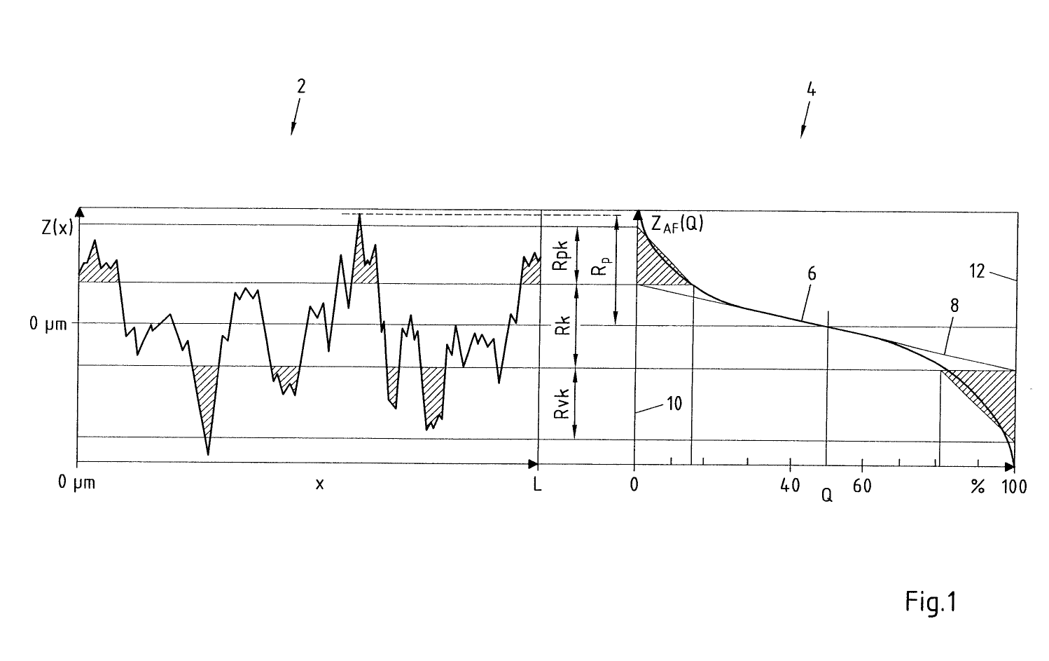

FIG. 1 is a schematic view of the determination of the maximum peak height Rₚ and the reduced peak height Rₚₖ in accordance with DIN EN ISO 13 565.

The left-hand region 2 of FIG. 1 shows a one-dimensional profile function Z(x) in an interval with the limits 0 and L. The function Z(x) provides a value Z(x) for each point x which corresponds to the local position of the actual surface, in other words the deviation in height of the surface from the average surface at <Z(x)>=0 μm.

The right-hand region 4 of FIG. 1 shows the so-called Abbott-Firestone curve Z_{AF}(Q) 6. This curve is the cumulative probability density function of the surface profile Z(x). It provides the height value Z_{AF} for a percentage value Q between 0 and 100% (shown on the abscissas), above which the relevant percentage share of the surface is found. The Abbott-Firestone curve Z_{AF}(Q) can implicitly be defined using the following equation:

$$Q = \frac{1}{L} {\int }_{Z ( x ) \geq {Z}_{AF} ( Q )} d x \qquad ( 6 )$$

L is the length of the profile Z(x) measured, in other words the size of the definition region of Z(x). The integration region is the part of the total length to which the inequality Z(x)≧Z_{AF}(Q) applies.

By placing a tangent 8 through the inflection point of the Abbott-Firestone curve 6, the points of intersection of this tangent 8 with the 0%-line 10 and the 100%-line 12 define a core region of the surface, the expansion of which is designated as the core roughness depth Rₖ. The averaged height determined of the peaks which extend out of the core region is designated as the reduced peak height Rₚₖ and the averaged depth determined of the grooves which extend out of the core region is designated as the reduced groove depth Rᵥₖ. Furthermore, the maximum peak height Rₚ is also plotted in FIG. 1, corresponding to the distance between the highest peaks and the average value at 0 μm.

The maximum peak height Rₚ and the reduced peak height Rₚₖ can be determined in practice, for example, from profiles Z(x) measured at various positions of the litho strip transverse to the direction of rolling.

The reduced peak height Sₚₖ can in practice be determined accordingly from a known surface measurement. The calculation is made analogue to the reduced peak height Rₚₖ, wherein the Abbott-Firestone curve ZAF (Q) for Sₚₖ can be defined implicitly using the following equation:

$$Q = \frac{1}{A} {\int \int }_{Z ( x , y ) \geq {Z}_{AF} ( Q )} d x d y \qquad ( 7 )$$

A is the size of the surface measured, in other words the size of the definition region of Z(x, y). The integration region is the part of the total length to which the inequality Z(x, y) Z_{AF}(Q) applies.

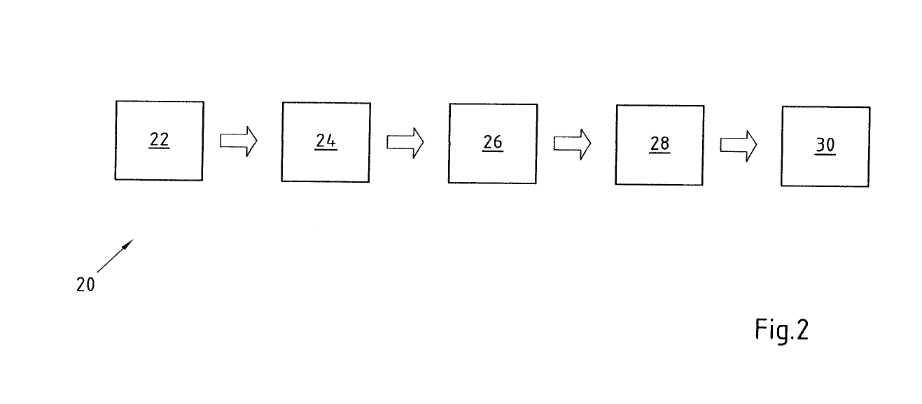

FIG. 2 shows an embodiment of the method in accordance with the invention for the manufacture of a litho strip. In the method 20, in a first step 22 an aluminium alloy is casted, for example an AA1050, AA1100, AA3103 or AlMg0.5 alloy, preferably an alloy with the following composition in percent by weight:

$$\begin{matrix}0.3 \% & \leq & Fe & \leq & 1.0 \% \\ 0.05 \% & \leq & Mg & \leq & 0.6 \% \\ 0.05 \% & \leq & Si & \leq & 0.25 \% \\ & & Mn & \leq & 0.05 \% \\ & & Cu & \leq & 0.04 \%\end{matrix}$$

plus an inflow of residual Al and unavoidable impurities, to an individual maximum of 0.05% and totaling a maximum of 0.15%.

The casting can generally be continuous or discontinuous, in particular it can be part of a continuous, semi-continuous or discontinuous casting process. In an optional step 24, the casting product, in other words in particular the cast ingots or the cast strip is subject to a further processing through a homogenisation treatment, for example in the temperature range between 480° C. and 620° C. for at least two hours. In the subsequent step 26 the casting product is optionally warm rolled, preferably to a thickness between 7 mm and 2 mm. Warm rolling can for example be foregone in a litho strip manufactured in a double strip casting process. The warm strip is then cold rolled in the step 28, in particular to a thickness between 0.5 mm and 0.1 mm. An intermediate annealing can take place optionally during the cold rolling. After the final cold rolling step, the litho strip is subject to a degreasing treatment with pickling with an aqueous pickling medium in a step 30, wherein the aqueous pickling medium contains at least 1.5% to 3% by weight a mixture of 5% to 40% sodium tripolyphosphate, 3% to 10% sodium gluconate, 3% to 8% non-ionic and anionic surfactants and optionally 0.5% to 70% soda, wherein the sodium hydroxide concentration in the aqueous pickling medium is between 0.1% and 5% by weight, in particular between 2% and 3.5% by weight, the degreasing treatment with pickling takes place at temperatures between 70 and 85° C. for a duration of between 1 and 3.5 seconds and a surface erosion of at least 0.25 g/m² is set by the degreasing treatment with pickling.

The selected surface erosion can reduce high roller webs in the surface of the strip such that after the degreasing treatment with pickling the litho strip has a topography with a maximum peak height Rₚ and/or Sₚ of a maximum of 1.4 μm, preferably a maximum of 1.2 μm, more preferably a maximum of 1.0 μm and is particularly suitable for CtP printing plate carriers.

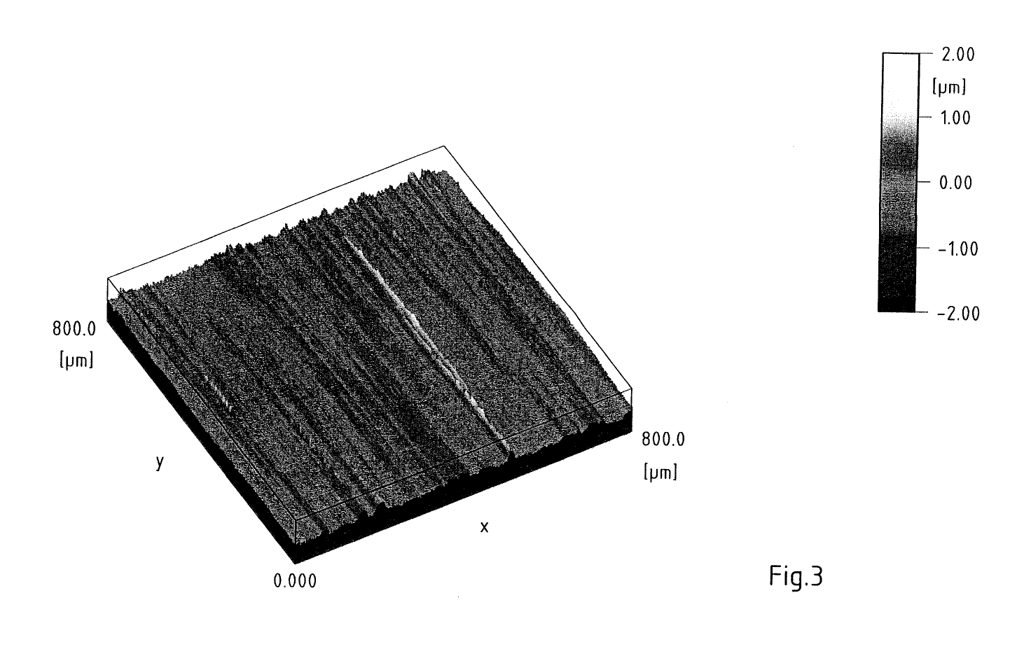

FIG. 3 shows the results of a 3D topographic measurement of a litho strip surface after the final cold rolling step. The figure shows a three-dimensional topographic view of the surface function Z(x, y) over a quadratic region with the side length 800 μm. The height information can additionally be taken from the scale on the right-hand side in FIG. 3. The y-axis lies parallel to the direction of rolling of the litho strip. It is shown that the litho strip has high roller webs longitudinal to the direction of rolling, in other words along the y-axis, which can be clearly seen as light elevations. These roller webs can disrupt the application of a photosensitive layer or even prevent it locally, such that printing errors occur when using printing plate carriers manufactured from these litho strips.

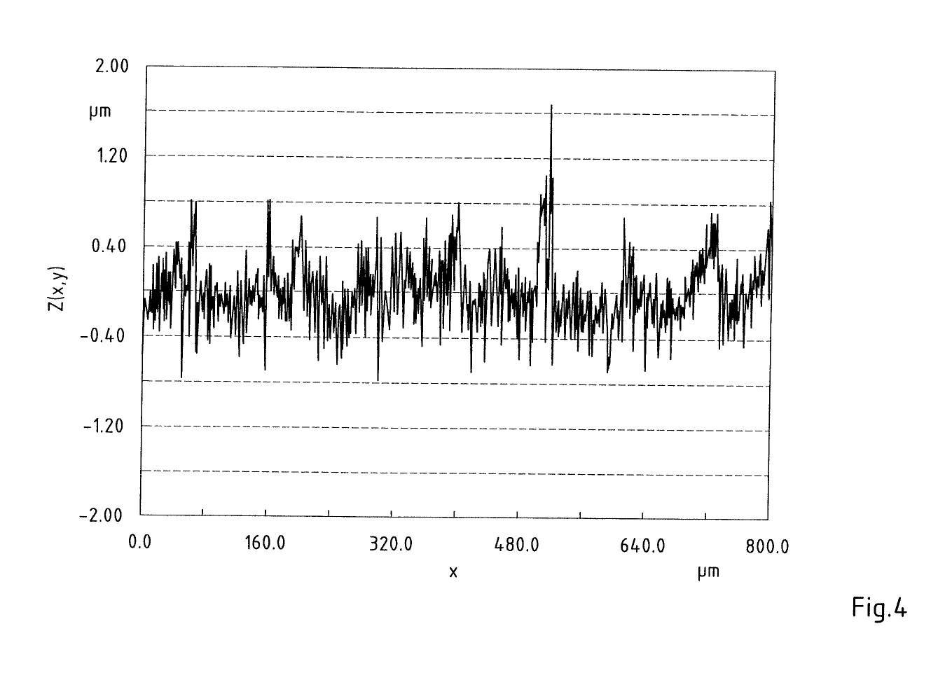

FIG. 4 shows a profile Z(x) from the topographic measurement shown in FIG. 3, in other words a section from the topographic measurement parallel to the x-axis. It is clearly visible that the roller webs in the litho band can have a height of more than 1.6 μm following the cold rolling. However, these high roller webs only have a slight influence on the value of the average roughness Rₐ of the litho strip.

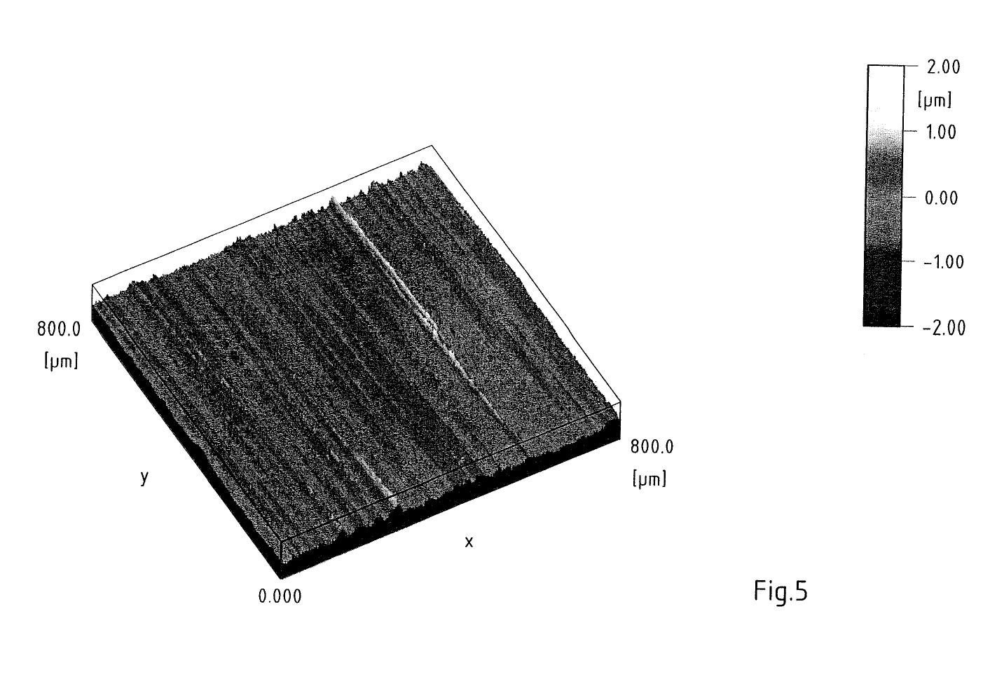

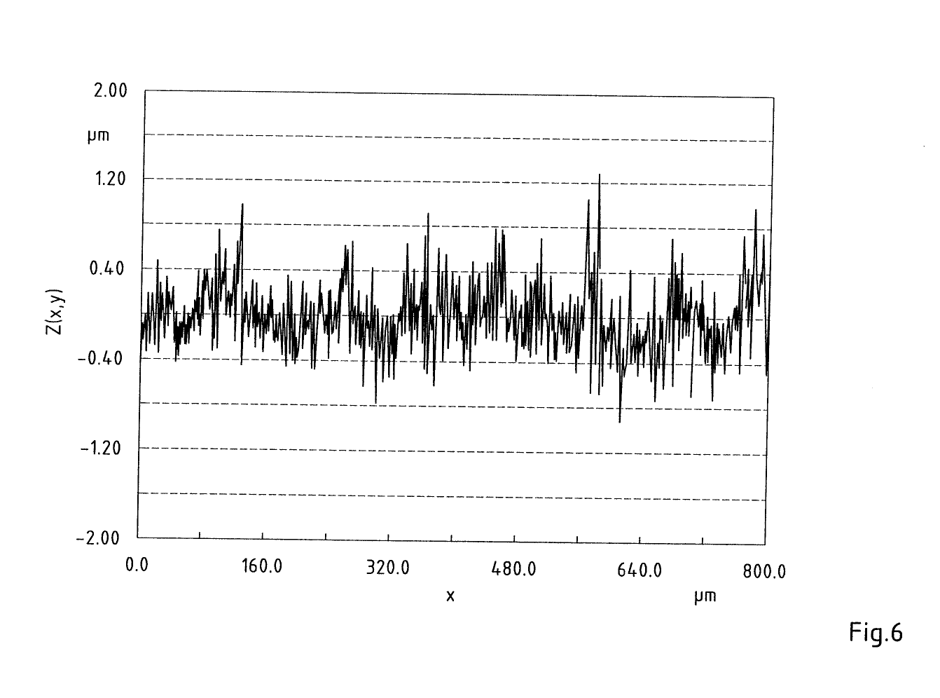

FIG. 5 shows the results of a topographic measurement on the surface of the litho strip from FIG. 1 after an embodiment of the method in accordance with the invention is carried out, in other words after the degreasing treatment with pickling as per the method in accordance with the invention. FIG. 5 essentially shows the same region of the litho strip as FIG. 3. As with FIG. 4, FIG. 6 shows an associated profile Z(x) from the topographic measurement shown in FIG. 5. FIGS. 5 and 6 show that in particular the high roller webs can be reduced considerably through the degreasing treatment with pickling. In FIG. 6, the maximum peak height Rₚ is only 1.3 μm and therefore considerably less than the maximum peak height Rₚ of the untreated litho strip from FIG. 4.

It is therefore possible to use the method in accordance with the invention to manufacture a strip surface with a maximum peak height Rₚ and/or Sₚ of a maximum of 1.4 μm, preferably a maximum of 1.2 μm, more preferably a maximum of 1.0 μm.

In order to ensure in practice that the maximum peak heights Rₚ are maintained in the production of the litho strips, three profile measurements can for example be taken transverse to the direction of rolling, on the outside and in the centre of the strip, wherein the length of the profile can for example be 4.8 mm. The value for Sₚ can be determined on the basis of a quadratic surface measurement with a side length of 800 μm.

As a comparison of FIGS. 4 and 6 shows, the average roughness Rₐ is barely influenced by the degreasing treatment with pickling. This parameter, which is used in the conventional manufacture and characterisation of litho strips, is therefore not suitable to show the existence of roller webs in the litho strips which may cause disturbances. In contrast to this, the quality of the litho strip surfaces can be better set using the roughness parameter of the maximum peak height Rₚ and/or Sₚ.

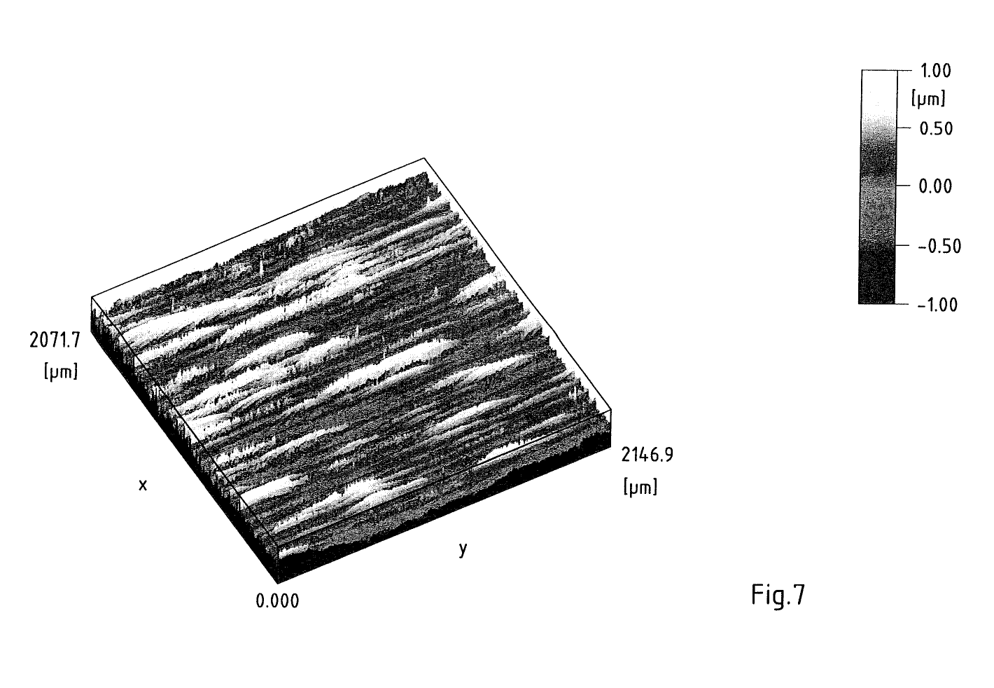

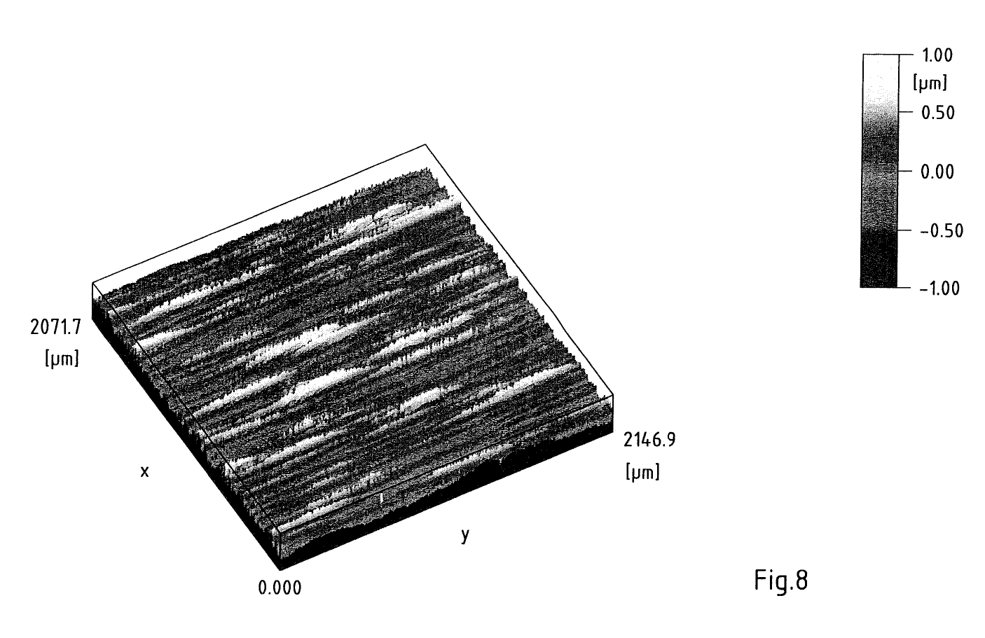

FIGS. 7 and 8 also show 3D topographic measurements of a litho strip surface with the length 2146.9 μm and the width 2071.7 μm immediately following the final cold rolling step (FIG. 7) and after a degreasing treatment with pickling is carried out as per the method in accordance with the invention (FIG. 8). In turn, the y-axis lies parallel to the direction of rolling of the litho strip. From a comparison of FIG. 8 with FIG. 7, it becomes apparent that the high roller webs longitudinal to the direction of rolling present in FIG. 7 can be reduced considerably through the degreasing treatment with pickling such that an improved litho strip surface is achieved.

A litho strip with a surface topography as shown in FIGS. 5, 6 and 8 can in particular be used advantageously as a printing plate carrier with a very flat roughening structure and/or in very thin photosensitive coatings, such as for example in CtP technology.

Additional features and characteristics of the invention can be derived from the roughness measurements taken from embodiments of the litho strip in accordance with the invention shown below.

Litho strips with an aluminium content which in addition to impurities caused by manufacture have the following alloy contents in percent by weight:

$$\begin{matrix}0.30 \% & \leq & Fe & \leq & 0.40 g \\ & & & & . \\ 0.10 \% & \leq & Mg & \leq & 0.30 \% \\ 0.05 \% & \leq & Si & \leq & 0.25 \% \\ & & Mn & \leq & 0.05 \% \\ & & Cu & \leq & 0.04 \%\end{matrix} \vert$$

plus residual Al, are cold rolled to a final thickness of 0.14 mm, 0.28 mm or 0.38 mm. In the degreasing treatment with simultaneous pickling, identical parameters are set as for the embodiment in FIG. 2.

Before and after the degreasing treatment, roughness measurements are taken on the upper sides of the litho strips, both in the edge regions and in the centre of the litho strips. The roughness measurements determine the average roughness Sₐ, the reduced groove depth Sᵥₖ, the reduced peak height Sₚₖ and the maximum peak height Sₚ. The results for the litho strip with a thickness of 0.14 mm are shown in table 1.

TABLE 1

| | Point of | | | | |
|---|---|---|---|---|---|
| Measurement | time of | | | | |
| position | measurement | Sₐ | Sᵥₖ | Sₚₖ | Sₚ |
| Edge region | Before | 0.22 | 0.23 | 0.35 | 1.9 |
| | degreasing | | | | |
| | After | 0.21 | 0.27 | 0.33 | 1.0 |
| | degreasing | | | | |
| Centre | Before | 0.21 | 0.26 | 0.35 | 1.6 |
| | degreasing | | | | |
| | After | 0.21 | 0.26 | 0.32 | 1.0 |
| | degreasing | | | | |

In the prior art, the average surface roughness Sₐ has been used to characterise the litho strips to date. Table 1 shows that this roughness parameter is not suitable to demonstrate the effect of the degreasing treatment with pickling in accordance with the invention or the surface quality of the litho strips in terms of individual high roller webs. Its value remains essentially unchanged after the degreasing treatment with pickling. The reduced groove depth Sᵥₖ is also evidently not suitable as an indicator of high roller webs. In contrast to this, the values for the maximum peak height Sₚ are considerably reduced and therefore show the improvement of the litho strip surfaces in terms of the damaging high roller webs. An optimisation of the litho strips and the method for their manufacture using the roughness parameter Sₚ therefore leads to a particularly infrequent occurrence of the above mentioned printing errors. The reduced peak height Sₚₖ is also decreased through the degreasing treatment with pickling and can be used as an additional roughness parameter.

TABLE 2

| | Sₚ (edge) | | Sₚ (centre) | |
|---|---|---|---|---|
| Strip | Before | After | Before | After |
| thickness | degreasing | degreasing | degreasing | degreasing |
| 0.14 mm | 1.9 | 1.0 | 1.67 | 1.1 |
| 0.28 mm | 1.61 | 1.2 | 1.38 | 1.1 |
| 0.38 mm | 1.3 | 1.0 | 1.3 | 1.1 |

Table 2 shows the results for the maximum peak height Sₚ from the roughness measurements on litho strips of different thicknesses. In particular, litho strips with a thickness of 0.3 mm to 0.1 mm benefit greatly from the method in accordance with the invention, as these have a relatively high Sₚ value of more than 1.5 μm immediately after the final cold rolling step and are therefore susceptible to the above mentioned printing errors. The maximum peak height Sₚ for all strip thicknesses measured can essentially be reduced to the same value through the degreasing treatment with pickling. As a consequence, the surface quality of thin litho strips can be improved particularly with the method in accordance with the present invention.

The results in tables 1 and 2 further show that high roller webs occur in particular on the edges of the strips. The degreasing treatment with pickling can therefore take place for example selectively in the edge region of the litho strips.

TABLE 3

| Point of | | | | |
|---|---|---|---|---|
| time of | | | | |
| measurement | Sₐ | Sᵥₖ | Sₚₖ | Sₚ |
| Before | 0.22 | 0.23 | 0.43 | 1.51 |
| degreasing | | | | |
| After | 0.21 | 0.24 | 0.37 | 1.13 |
| degreasing | | | | |

Table 3 shows the roughness parameters Sₐ, Sᵥₖ, Sₚₖ and Sₚ determined in average on litho strips of different thicknesses. The results clearly show that the average roughness Sₐ which has been used to date to characterise litho strips is not suitable to improve the quality of a litho strip surface in terms of the damaging high roller webs. In contrast to this, the values of the maximum peak height Rₚ and/or Sₚ and the reduced peak height Rₚₖ and/or Sₚₖ after the degreasing treatment with pickling show a considerable reduction, such that the litho strip and the method for its manufacture can be improved considerably by an optimisation of the parameters Rₚ and/or Sₚ, where necessary in combination with Rₚₖ and/or Sₚₖ.

In order to manufacture the litho strip in accordance with the invention, the method in accordance with the invention can for example be used. However, the litho strip in accordance with the invention is not limited to this method of manufacture. On the basis of the present invention, the person skilled in the art can develop further methods to achieve a litho strip in accordance with the invention by optimising the roughness parameter Rₚ and/or Sₚ.

1. Litho strip for electrochemical roughening, consisting of a rolled aluminium alloy, characterised in that the strip surface has a topography with a maximum peak height Rₚ and/or Sₚ of a maximum of 1.4 μm, preferably a maximum of 1.2 μm, more preferably a maximum of 1.0 μm.

2. Litho strip according to claim 1, characterised in that the strip surface has a topography with a reduced peak height of Rₚₖ and/or Sₚₖ of a maximum of 0.4 μm, preferably a maximum of 0.37 μm.

3. Litho strip according to either claim 1 or claim 2, characterised in that the thickness of the litho strip is between 0.5 mm and 0.1 mm.

4. Litho strip according to any one of claims 1 to 3, characterised in that the litho strip consists of an AA1050, AA1100, AA3103 or AlMg0.5 alloy.

5. Litho strip according to any one of claims 1 to 4, characterised in that the litho strip has the following alloy composition in percent by weight:
$$\begin{matrix}0.3 \% & \leq & Fe & \leq & 1.0 \% \\ 0.05 \% & \leq & Mg & \leq & 0.6 \% \\ 0.05 \% & \leq & Si & \leq & 0.25 \% \\ & & Mn & \leq & 0.05 \% \\ & & Cu & \leq & 0.04 \%\end{matrix} \vert$$
plus residual Al and unavoidable impurities, to an individual maximum of 0.05% and totaling a maximum of 0.15%.

6. Litho strip according to any one of claims 1 to 5, characterised in that the litho strip has the following alloy content in percent by weight:
$$\begin{matrix}0.3 \% & \leq & Fe & \leq & 0.4 \% \\ 0.1 \% & \leq & Mg & \leq & 0.3 \% \\ 0.05 \% & \leq & Si & \leq & 0.25 \% \\ & & Mn & \leq & 0.05 \% \\ & & Cu & \leq & 0.04 \%\end{matrix} \vert$$

7. Litho strip according to any one of claims 1 to 6, characterised in that the impurities in the alloy of the litho strip have the following threshold values in percent by weight:
$$\begin{matrix}Cr & \leq & 0.01 \% \\ Zn & \leq & 0.02 \% \\ Ti & \leq & 0.04 \% \\ B & \leq & 50 ppm .\end{matrix}$$

8. Method for the manufacture of a litho strip of this type, in particular a litho strip according to claims 1 to 7, in which a litho strip consisting of an aluminium alloy is cold rolled and in which after the final cold rolling action the litho strip is subject to a degreasing process with a simultaneous pickling process in an aqueous pickling medium, wherein the aqueous pickling medium contains at least 1.5% to 3% by weight of a mixture of 5% to 40% sodium tripolyphosphate, 3% to 10% sodium gluconate, 3% to 8% non-ionic and anionic surfactants and optionally 0.5% to 70% soda and the sodium hydroxide concentration in the aqueous pickling medium is between 0.1% and 5% by weight, characterised in that the surface erosion caused by the degreasing treatment with simultaneous pickling is at least 0.25 g/m².

9. Method according to claim 8, characterised in that the sodium hydroxide concentration in the aqueous pickling medium is between 2% and 3.5% by weight and optionally the degreasing treatment with pickling takes place at temperatures between 70° C. and 85° C. for a duration of between 1 and 3.5 seconds.

10. Method according to either claim 8 or claim 9, characterised in that the pickling temperature is between 76° C. and 84° C. and/or the sodium hydroxide concentration in the aqueous pickling medium is between 2.6% and 3.5% by weight.

11. Method according to any one of claims 8 to 10, characterised in that the pickling duration is between 1 and 2 seconds, preferably between 1.1 and 1.9 seconds.

12. Method according to any one of claims 8 to 11, characterised in that the litho strip is rolled to a final thickness of 0.5 mm to 0.1 mm in the final cold rolling step.

13. Method according to any one of claims 8 to 12, characterised in that AA1050, AA1100, AA3103 or AlMg0.5 are used as an aluminium alloy.

14. Method for the manufacture of a printing plate carrier, wherein the printing plate carrier has a topography with a maximum peak height Rₚ and/or Sₚ of a maximum of 1.4 μm, at which the printing plate carrier is manufactured from a litho strip according to any one of claims 1 to 7.

15. Method according to claim 14, characterised in that the printing plate carrier has a photosensitive coating with a thickness of less than 2 μm.

16. Use of a printing plate carrier manufactured according to either claim 14 or claim 15 for a CtP printing plate.
